(19) United States
(12) Patent Application Publication
(10) Pub. No.: US 2026/0339658 A1
(43) Pub. Date: Oct. 29, 2026

(54) SYSTEMS AND METHODS FOR CREATING SOURCE-TO-TARGET MAPPING DOCUMENTATION

(71) Applicant: The PNC Financial Services Group, Inc., Pittsburgh, PA (US)

(72) Inventors: Daniel White, Pittsburgh, PA (US); Jose Morales, Pittsburgh, PA (US)

(21) Appl. No.: 19/389,380

(22) Filed: Nov. 14, 2025

Related U.S. Application Data
(63) Continuation of application No. 19/308,495, filed on Aug. 25, 2025.
(60) Provisional application No. 63/708,902, filed on Oct. 18, 2024.
(60) Provisional application No. 63/810,875, filed on May 23, 2025.

(51) Int. Cl. G06F 8/73; G06F 8/30

(52) U.S. Cl. CPC G06F 8/73; G06F 8/315

(57) ABSTRACT

Computer-implemented methods and systems for improving the efficiency of creating source-to-target mapping documentation are provided. Some embodiments involve receiving a template for creating a code script that executes data transformations. Some receiving the code script for executing data transformations. Some embodiments involve comparing the structure of a code script against the template and providing a warning for a portion of the code script that fails to conform to the template based on the comparing. Some embodiments involve providing the code script and the data transformation results to a documentation generator. Some embodiments involve analyzing the code script and the data transformation results. In some embodiments, the analysis includes identifying a source and target as executed by the code script and the data transformations. Some embodiments involve generating an output document that shows the data lineage of an identified source data.

### CROSS REFERENCE TO RELATED APPLICATIONS

This application claims the benefit of priority of U.S. Provisional Patent Application No. 63/708,902 filed on Oct. 18, 2024 and U.S. Provisional Patent Application No. 63/810,875 filed on May 23, 2025, the contents of which are incorporated herein by reference in their entirety.

### BACKGROUND

Institutions may have access to large amounts of consumer information, including financial data. This data must be kept secure while simultaneously being easily accessible so that it may be utilized across the institution. When accessing and moving data, developers may use Source-to-Target Mapping (STM) code that (1) identifies a data source, (2) performs data transformations (if necessary), and (3) maps the corresponding data source to a target field. STM documentation may be used in data integration and migration projects. STM documentation may define how data fields from a source system correspond to a target system. Proper documentation may assist with confirming that the data is accurate, complete, and consistent. Developers may structure their STM code in different ways and create STM documentation after executing their code. This documentation may also be different depending on who is creating it due to varying documentation practices. Having disparate structures for STM code and STM documentation creates difficulty in comprehending documentation and code.

Accordingly, in view of these and other deficiencies in current techniques, technical solutions are needed to increase the efficiency for creating and standardizing STM code and documentation.

### SUMMARY OF THE DISCLOSURE

The disclosed embodiments describe computer readable mediums, systems, and methods for efficiently creating STM documentation and a log of best practices. For example, the systems and methods may include receiving a template for structuring a code script that executes data transformations. The systems and methods may further include receiving the code script for executing data transformations and comparing the structure of a code script against the template and providing a warning for a portion of the code script that fails to conform to the template based on the comparing. The systems and methods may further include, revising the code script based on the provided warning to conform to the template and executing the code script to create data transformation results. The systems and methods may further include, providing the code script and the data transformation results to a documentation generator and analyzing the code script and the data transformation results, including identifying a source and target as executed by the code script and the data transformations. Further, the systems and processes may include, generating, using the documentation generator, source-to-target mapping documentation based on the code script and transformation results. In some embodiments, the source-to-target mapping documentation includes a target attribute, a source attribute, a source table, a transformation, a log of information collection progress, and a warning if any collection fails. Further, the systems and processes may include, outputting the source-to-target mapping documentation in a predefined format.

According to some embodiments, the predefined format for outputting the source-to-target mapping documentation is a spreadsheet.

According to some embodiments, the code script may be coded in languages PySpark, Hive SQL, or Oracle SQL.

According to some embodiments, the system and process provides suggestions for amending the code script to conform to the template for creating code scripts.

Throughout this disclosure the phrase “disclosed embodiments” refers to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. Likewise, the fact that some “disclosed embodiments” are described as exhibiting a feature or characteristic does not mean that other disclosed embodiments cannot share that feature or characteristic.

It is to be understood that both the foregoing general description and the following detailed description are exemplary and explanatory only, and are not restrictive of the disclosed embodiments, as claimed.

### BRIEF DESCRIPTION OF THE DRAWINGS

FIG. 1 illustrates a need for creation of standardized STM documentation, consistent with some disclosed embodiments.

FIG. 2 illustrates a system for importing STM code into an automation process that creates STM documentation and a log of best practices, consistent with some disclosed embodiments.

FIG. 3 is a diagram of an exemplary system creating automated STM documentation, consistent with some disclosed embodiments.

FIG. 4 is a block diagram showing an example computing device, consistent with some disclosed embodiments.

FIG. 5 is a flowchart illustrating an example process for automatically creating STM documentation using a standard coding template, consistent with some disclosed embodiments.

FIG. 6 illustrates an exemplary system architecture for generating source-to-target mapping documentation using a template and automated processing pipeline, consistent with some disclosed embodiments.

FIG. 7 is a flowchart illustrating an example process for linking source-to-target mapping documents in a manner that permits data lineage tracking, consistent with some disclosed embodiments.

FIG. 8 illustrates the process for linking source-to-target mapping documents in a manner that permits data lineage tracking, consistent with some disclosed embodiments.

FIG. 9 illustrates an exemplary system architecture for analyzing source-to-target mapping documentation and linking them according to data lineage, consistent with the disclosed embodiments.

FIG. 10 is a flowchart illustrating an example process for modifying source-to-target mapping templates, consistent with some disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

Reference will now be made in detail to the disclosed embodiments, which are illustrated in the accompanying drawings.

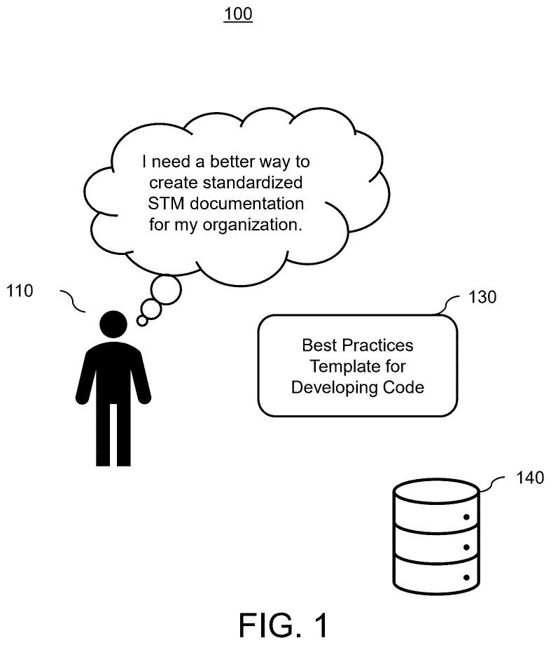

FIG. 1 illustrates a need for creation of standardized STM documentation, consistent with some disclosed embodiments. Exemplary system 100 represents a need, which may not be understood in the art, for creating STM documentation. According to this need, an entity 110 may develop their own documentation, which may greatly differ between entities. For example, an entity, such as entity 110, may manually input STM documentation data into a spreadsheet. This documentation data may include target attributes, corresponding business definitions, source attributes, source tables, transformations, a log of information collection progress, and a flag for any failed collections. Moreover, the entity may have a best practices template for developing code 130 that executes STM instructions. The best practices may include a template for creating code scripts. A template may include step-by-step instructions that a developer may follow for structuring, testing, and validating code scripts. A template may also include flowcharts, diagrams, checklists, code outlines, training modules, formal standard operating procedures, or general guidance. Examples of best practices that may be in a template may include only importing necessary functions and attributes rather than importing entire modules, only having one source table, and including one attribute per line of code. The code that executes STM instructions may source, add, or transform data located within a database 140. As illustrated in FIG. 1, entity 110, which may be an individual, a financial institution, or an organization, may need to create STM documentation that is standardized within an organization in a fast and accurate manner.

The systems and methods disclosed herein may utilize a coding template, code scripts conforming with that template, and an STM documentation generator, while allowing entity 110 to focus on completing STM code without having to spend time on documentation. While FIG. 1 only illustrates entity 110, the disclosed systems and methods may be applicable to any number of entities 110, or any other persons or entities consistent with the present disclosure.

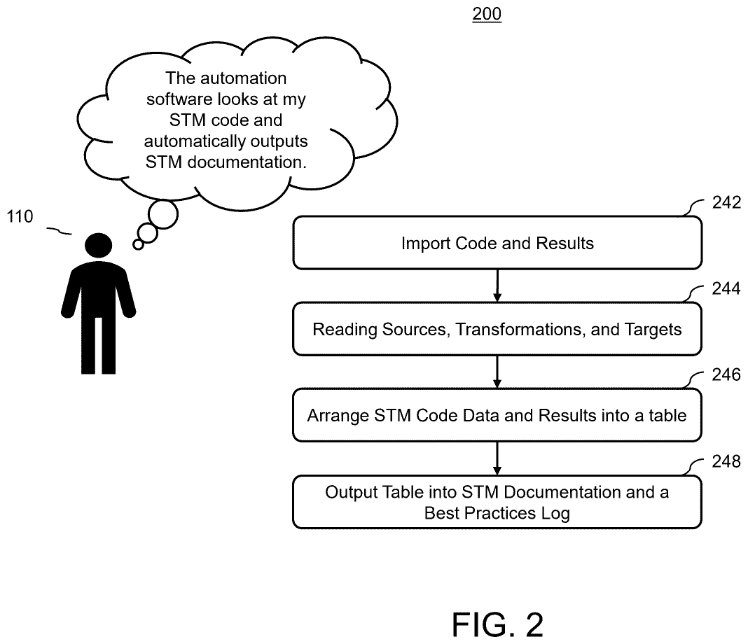

FIG. 2 illustrates an exemplary system 200 for creating STM documentation. As illustrated in FIG. 2, a process that automatically generates STM documentation and a log of best practices may include a variety of steps. The embodiment shown in FIG. 2 is merely illustrative.

As illustrated in FIG. 2, STM code script in accordance with best practices may be fed into a documentation generator that may include the steps of importing the code and results 242, reading sources, transformations, and targets 244, and arranging STM code data and results into a table 246. According to some embodiments, the code used to execute STM operations may be implemented in accordance with best practices. The best practices may include a template for creating code scripts. A template may include step-by-step instructions that a developer may follow for structuring, testing, and validating code scripts. A template may also include flowcharts, diagrams, checklists, code outlines, training modules, formal standard operating procedures, or general guidance. Examples of best practices that may be in a template may include only importing necessary functions and attributes rather than importing entire modules, only having one source table, and including one attribute per line of code. Further, according to some embodiments, code scripts may include a set of instructions written in a programming language such as SQL, Python, VBA, and Java. Further, these code scripts may execute data transformations, which may manipulate or rearrange data.

The process may require the documentation generator to import the code and the results 242 of executing the STM script in the STM documentation generator 240. According to some embodiments, this step may require a set of computer instructions that retrieves the code and the results 242, which may be stored in one or more databases.

The process may further require identifying the sources, transformations, and targets 244. The process may further require arranging STM code data and results into a table 246. According to some embodiments, the results may be organized in either a table format or into diagrams, flow charts, or written reports. Further, after organizing the results, the STM code data and results may be put into either STM documentation or a best practices log. For example, the STM documentation generator may arrange a table that contains target attributes, corresponding business definitions, source attributes, source tables, transformations, a log of information collection progress, and a data-collection warning within the STM documentation computer code. Then, the table or other arrangement of organized data may then be made into STM documentation.

The process may, at step 248, further output the table into STM documentation and a best practices log. The output may take the form of an Excel spreadsheet. Also, the data relevant to the best practices, such as non-compliance with the best practices template, may be outputted as text, a spreadsheet, or another report. As illustrated in FIG. 2, an entity 110 may need to create STM documentation and a log of best practices. According to some embodiments, the STM documentation may include target attributes, corresponding business definitions, source attributes, source tables, transformations, a log of information collection progress, and a data-collection warning. Further, according to some embodiments, the format for outputting the STM documentation may be a spreadsheet. The predefined format may be determined by an entity such as a person, corporation, or organization and include formats such as flowcharts, diagrams, and metadata. According to some embodiments, the log of best practices may include an analysis of how closely the code script followed the template of best practices. For example, the best practice template may require variable naming to follow a convention that identifies the source and target databases. However, if the code script runs afoul of this best practice, the log may identify it and output it into a form that describes the nature of the non-conformance. In some embodiments, the best practices log may recommend or take actions to remedy the non-conformance such as suggesting an entity to change the variable name or making the change automatically using a programmed set of instructions.

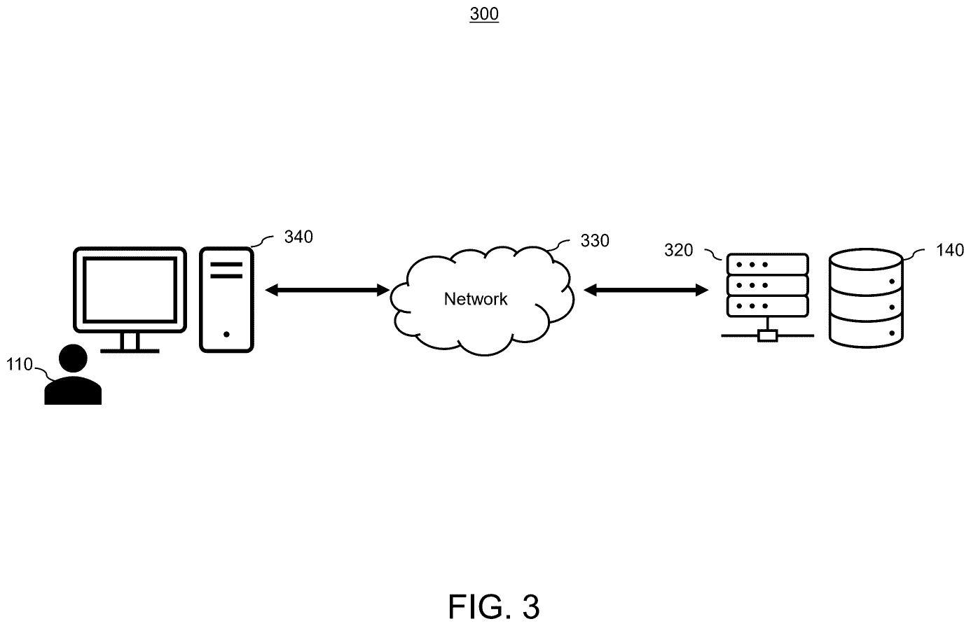

FIG. 3 is a diagram of an exemplary system environment 300 for creating automated STM documentation and best practices log, consistent with disclosed embodiments. System environment 300 may include one or more financial institution endpoint devices 340, one or more computing devices 320, and one or more databases 140.

The various components of system environment 300 may communicate over a network 330. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment 300 is shown as a network-based environment, it is understood that in some embodiments, one or more aspects of the disclosed systems and methods may also be used in a localized system, with one or more of the components communicating directly with each other.

Computing device 320 may include any form of remote computing device configured to receive, store, and transmit data. For example, computing device 320 may be a server configured to store files accessible through a network (e.g., a web server, application server, virtualized server, etc.). Computing device 320 may interact with a database 140, to receive and/or store information. Database 140 may be included on a volatile or non-volatile, magnetic, semiconductor, tape, optical, removable, non-removable, or other type of storage device or tangible or non-transitory computer-readable medium. Database 140 may also be part of computing device 320 or separate from computing device 320. When database 140 is not part of computing device 320, computing device 320 may exchange data with database 140 via a communication link. Database 140 may include one or more memory devices that store data and instructions used to perform one or more features of the disclosed embodiments. Database 140 may include any suitable databases, ranging from small databases hosted on a work station to large databases distributed among data centers. Database 140 may also include any combination of one or more databases controlled by memory controller devices (e.g., server(s)) or software. For example, database 140 may include document management systems, Microsoft SQL™ databases, SharePoint™ databases, Oracle™ databases, Sybase™ databases, other relational databases, or non-relational databases, such as MongoDB and others. Although one database 140 is shown in FIG. 3, the system environment 300 may include one or more databases 140, which may be used to store various types of information associated with customers of a financial institution.

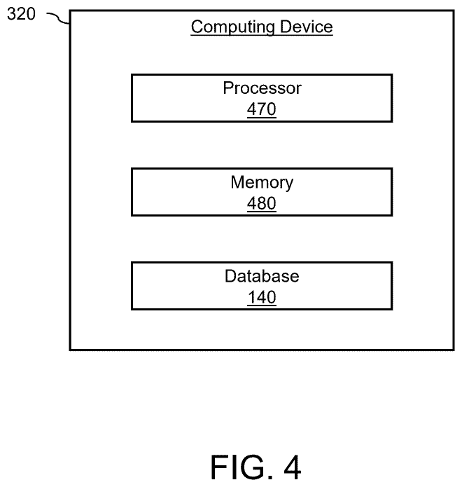

FIG. 4 is block diagram showing an example computing device 320, consistent with the disclosed embodiments. As described above, computing device 320 may be one or more devices configured to allow data to be received and/or transmitted by system environment 300 (e.g., a server) and may include one or more dedicated processors and/or memories. For example, computing device 320 may include a processor (or multiple processors) 470, and a memory (or multiple memories) 480, as shown in FIG. 4. Computing device 320 may include one or more digital and/or analog devices that may allow computing device 320 to communicate with other machines and devices, such as other components of system 300. Computing device 320 may include one or more input/output devices. Computing device 320 may include a screen for displaying communications to a user. In some embodiments, computing device 320 may include a touch screen. Computing device 320 may include other components known in the art for interacting with a user. Computing device 320 may also include one or more digital and/or analog devices that may allow a user to interact with system environment 300, such as touch-sensitive area, keyboard, buttons, or microphones.

Processor 470 may take the form of, but is not limited to, one or more integrated circuits (IC), including application-specific integrated circuit (ASIC), microchips, microcontrollers, microprocessors, embedded processor, all or part of a central processing unit (CPU), graphics processing unit (GPU), digital signal processor (DSP), field-programmable gate array (FPGA), server, virtual server, system on a chip (SOC) or other circuits suitable for executing instructions or performing logic operations. Furthermore, according to some embodiments, processor 470 may be from the family of processors manufactured by Intel®, AMD®, Qualcomm®, Apple®, NVIDIA®, or the like. The processor 470 may also be based on the ARM architecture, a mobile processor, or a graphics processing unit, etc. The disclosed embodiments are not limited to any type of processor configured in computing device 320. In some embodiments, processor 470 may be a special purpose processor configured to perform one or more of the operations described below.

Memory 480 may include one or more storage devices configured to store instructions used by the processor 470 to perform functions related to computing device 320. The disclosed embodiments are not limited to particular software programs or devices configured to perform dedicated tasks. For example, the memory 480 may store a single program, such as a user-level application, that performs the functions associated with the disclosed embodiments or may include multiple software programs. Additionally, the processor 470 may, in some embodiments, execute one or more programs (or portions thereof) remotely located from computing device 320. Furthermore, memory 480 may include one or more storage devices configured to store data for use by the programs. Memory 480 may include, but is not limited to, a hard drive, a solid-state drive, a CD-ROM drive, a peripheral storage device (e.g., an external hard drive, a USB drive, etc.), a network drive, a cloud storage device, or any other storage device.

Computing device 320 may include a database 140 as described above. Database 140 may also be part of computing device 320 or separate from computing device 320. In some embodiments, computing device 320 may include one or more input/output devices, communications devices, displays, and/or other interfaces (e.g., server-to-server, database-to-database, or other network connections). One or more of financial institution endpoint devices 340 may include components similar to those discussed with respect to computing device 320 and may perform functions similar to or different from those described above with respect to computing device 320.

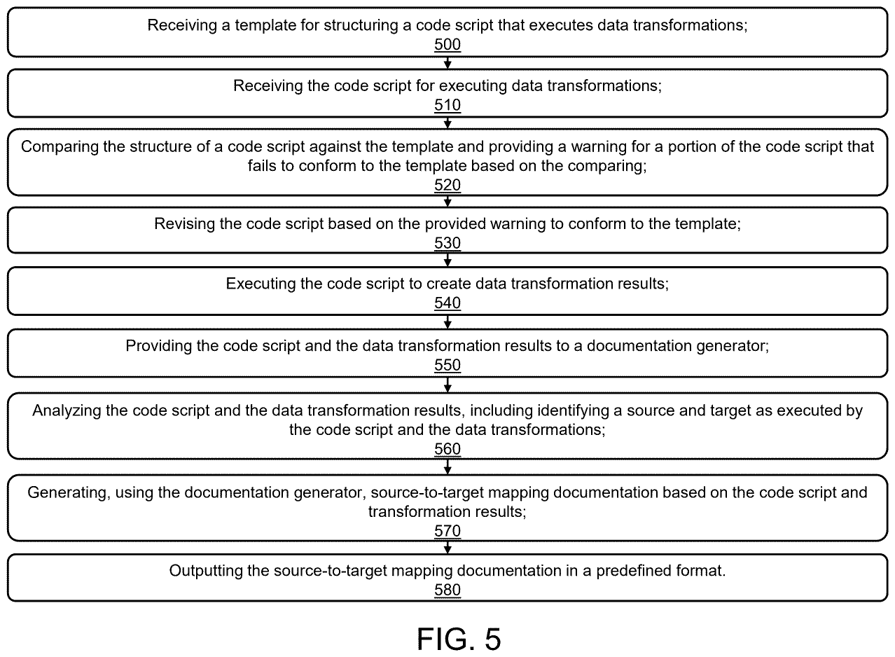

FIG. 5 is a flowchart illustrating an example process for automatically creating STM documentation using a standard coding template.

In step 500, the process may include receiving a template for structuring a code script that executes data transformations. According to some embodiments, a template for creating code scripts may include step-by-step instructions that a developer may follow for structuring, testing, and validating code scripts. A template may also include flowcharts, diagrams, checklists, code outlines, training modules, formal standard operating procedures, or general guidance. Further, according to some embodiments, code scripts may include a set of instructions written in a programming language such as SQL, Python, VBA, and Java. Further, these code scripts may execute data transformations which may manipulate or rearrange data. For example, a code script may import two pieces of data that are two separate strings, “FirstString” and “SecondString.” Appending these two strings to make “FirstStringSecondString” and storing them as a new piece of data is an example of a data transformation. Data transformations may also include aggregating, summarizing, normalizing, or relocating data. The code script may include instructions that (1) identifies a data source, (2) performs data transformations (if necessary), and (3) maps the corresponding data source to a target field.

In step 510, the process may further include receiving the code script for executing data transformations. The code script may be written by a developer or generated by an algorithm and may follow, in whole or in part, the structure defined by the template. The script may include instructions for extracting data from one or more sources, applying transformation logic, and mapping the results to target fields.

In step 520, the process may further include comparing the structure of a code script against the template and providing a warning for a portion of the code script that fails to conform to the template based on the comparing. According to some embodiments, incompliant code may be flagged, and the documentation generator or other software may provide feedback on the non-compliant code and recommend steps to bring the code script within substantial compliance. In other words, according to some embodiments, the process provides suggestions for amending the code script to conform to the template for creating code scripts. According to some embodiments, the code script may be written by a person or algorithm. Further, total compliance with the template may not be necessary for the process.

In step 530, the process may further include revising the code script based on the provided warning to conform to the template. This revision may be performed manually by a developer or automatically by a system. The goal of this step may be to ensure that the code script is structured in a way that supports reliable documentation generation and traceability in further steps.

In step 540, the process may further include executing the code script to create data transformation results. According to some embodiments, the code script may be coded in languages such as PySpark, Hive SQL, or Oracle SQL. Further, according to some embodiments, executing code scripts may include translating the code into machine language and running the code to perform the written instructions. In the process, a computer network, such as the network depicted in FIG. 3, may provide a system environment that the code may be executed within.

In step 550, the process may further include providing the code script and the data transformation results to a documentation generator. According to some embodiments, the documentation generator may be written in a programming language such as SQL, Python, VBA, and Java. Alternatively, the documentation generator may be included in the code script that may execute data transformations, which may manipulate or rearrange data.

In step 560, the process may further include analyzing the code script and the data transformation results, including identifying a source and target as executed by the code script and the data transformations. For example, the code script may provide instructions to a computer to pull the strings “FirstString” and “SecondString” from one or more databases. In some scenarios, a processor may fail to pull the strings. Further, this failure may result in the inability to manipulate the data. This may be reflected in the data transformation results. The analysis may determine whether the code script followed the template, what the results were, and why failures may have occurred (e.g., data does not exist).

In further embodiments, the analysis may be performed using rule-based engines, pattern recognition algorithms, or machine learning models trained on historical code and documentation. These techniques may enhance the process's ability to detect implicit mappings, transformation patterns, or anomalies in the code or results.

In step 570, the process may further include generating, using the documentation generator, source-to-target mapping documentation based on the code script and transformation results. According to some embodiments, the source-to-target mapping documentation includes a target attribute, a source attribute, a source table, a transformation, a log of information collection progress, and a data-collection warning.

In step 580, the process may further include outputting the source-to-target mapping documentation in a predefined format. According to some embodiments, the predefined format for outputting the source-to-target mapping documentation may be a spreadsheet. Further, according to some embodiments, the predefined format may be determined by an entity such as a person, corporation, or organization and include formats such as flowcharts, diagrams, and metadata.

In further embodiments, changes to the code script automatically update the source-to-target mapping documentation. For example, after the process creates STM documentation into a predefined format, any future changes to the code script that created the STM documentation will prompt the process to create revised STM documentation. Further embodiments may include STM documents or code scripts with version history.

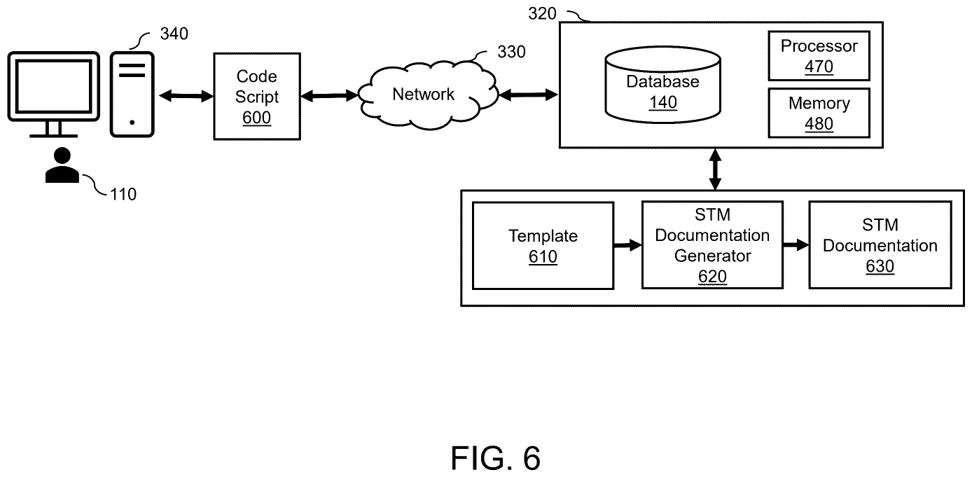

FIG. 6 illustrates an exemplary system architecture for generating source-to-target mapping documentation using a template and automated processing pipeline, consistent with the disclosed embodiments. The process begins with entity 110, which may be a developer, organization, or financial institution, authoring a code script on a computing device represented by endpoint device 340. The code script 600 may contain instructions for executing data transformations and is structured according to a template 610. The template may provide guidance on how to organize the script, including naming conventions, transformation logic, and documentation standards, ensuring consistency and facilitating automated analysis.

Once authored, the code script may be executed by a processor 470, which may interpret the instructions and perform the data transformations. During execution, the processor may interact with a database 140, which may store the source data, transformation rules, and target schema definitions. The processor may also utilize memory 480, to store intermediate results, execution metadata, and temporary data structures necessary for efficient processing.

Following execution, the code script and its transformation results may be passed to the STM documentation generator 620. This component may analyze the script and the results to identify source fields, transformation logic, target fields, and any warnings or errors encountered during processing. Based on this analysis, the generator may compile structured STM documentation 630. The documentation may include a target attribute, a source attribute, a source table, transformation logic, a log of information collection progress, and/or data-collection warnings. According to some embodiments, the documentation may be outputted in a predefined format, such as a spreadsheet or structured report, enabling traceability, auditability, and compliance with internal standards or regulatory requirements.

Throughout this process, the system components may communicate over a network 330 which may include local area networks (LAN), wide area networks (WAN), or cloud-based infrastructure. This networked environment may enable distributed processing and access to remote databases or documentation services, supporting scalability and integration across enterprise systems.

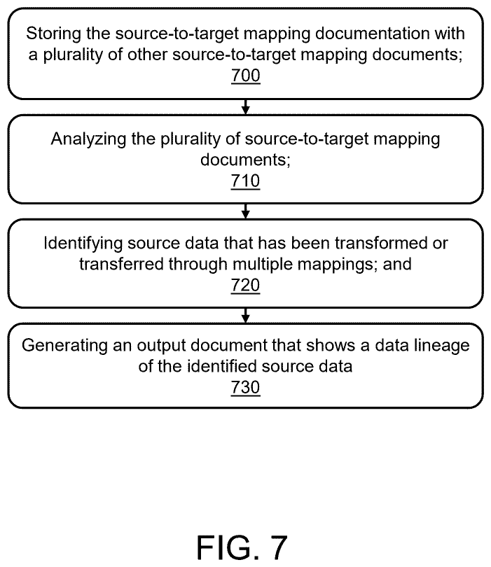

FIG. 7 is a flowchart illustrating an example process for linking source-to-target mapping documents in a manner that permits data lineage tracking. Data lineage tracking, in this context, refers to the ability to trace the origin, transformation, and destination of data as it moves through various stages of processing and documentation. By maintaining a historical record of how data flows from source-to-target—including intermediate transformations and mappings—the system can identify patterns of non-compliance, inefficiencies, or inconsistencies in documentation practices. This historical data enables the system to assess whether template modifications lead to measurable improvements in documentation quality, such as reduced error rates, increased consistency, or faster generation times. Furthermore, lineage tracking supports auditability and transparency, allowing stakeholders to verify the integrity of data transformations and ensure compliance with internal standards or regulatory requirements.

In step 700, the process may include storing the source-to-target mapping documentation with a plurality of other source-to-target mapping documents. For example, STM documents may originate from different systems or data pipelines. For example, a financial institution may store STM documents that describe how transaction data is extracted from a customer database, transformed for compliance checks, and loaded into a reporting system.

In step 710, the process may further include analyzing the plurality of source-to-target mapping documents. For example, analysis may involve parsing the documents to extract metadata such as source fields, transformation logic, target fields, and system identifiers. The system may use pattern recognition, rule-based logic, or machine learning techniques to identify relationships between mappings and transformations within STM documentation. For instance, the system may detect that a field labeled “Transaction Flag” in one STM document is derived from a transformation applied to “Account Transaction” in another document.

In step 720, the process may further include identifying source data that has been transformed or transferred through multiple mappings. This step may involve tracing the lineage of a specific data element across several STM documents to determine its origin, transformation history, and final destination. For example, the system may identify that a “Transaction Report” field in a regulatory reporting database is ultimately derived from a customer's original transaction data, which passed through multiple transformation steps including threshold flagging and aggregation.

In step 730, the process may further include generating an output document that shows the data lineage of the identified source data. The output document may take various forms, including a graphical representation (e.g., a flow diagram showing the path of data across systems), a textual description, or a structured table. This output may be used for auditing, debugging, compliance verification, or integration with data governance platforms.

In further embodiments, the system may support real-time lineage tracking by continuously analyzing new STM documents and updating lineage views dynamically. This may be useful in environments with frequent schema changes or evolving data pipelines.

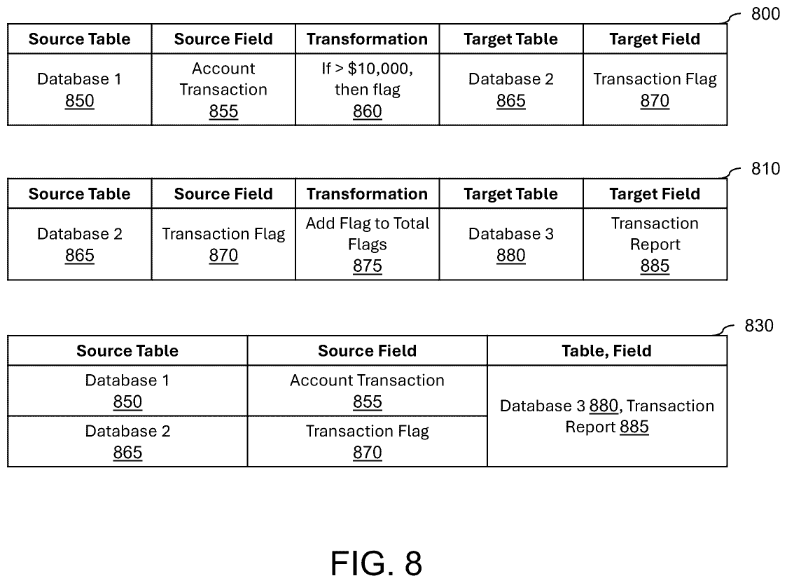

FIG. 8 illustrates the process for linking source-to-target mapping documents in a manner that permits data lineage tracking. For example, under the Bank Secrecy Act, financial institutions may be required to report cash transactions that exceed $10,000. As a result, a bank may be required to track transactions that exceed this threshold. FIG. 8 demonstrates how STM documentation may be used to track the lineage of data that ultimately ends up in a report or used elsewhere.

FIG. 8 comprises three tables labeled 800, 810, and 830, each representing a stage in the transformation and transfer of data typically recorded in STM documents.

Table 800 depicts a first mapping and transformation operation in which data originates from a source table labeled Database 1 850. Within this table, the source field is identified as Account Transaction 855. An account transaction may be derived from an actual transaction made from a banking customer, for example, withdrawing $10,000. As shown in FIG. 8, a transformation is applied to this field, defined as “If >$10,000, then flag” 860, which evaluates the transaction amount and flags it if it exceeds the specified threshold. The result of this transformation is stored in a target table labeled “Database 2” 865, specifically in the target field “Transaction Flag” 870.

Table 810 illustrates a second mapping and transformation operation that builds upon the output of the first. Here, the source table is “Database 2” 865, and the source field is “Transaction Flag” 870, which was generated in the previous step. A new transformation is applied, described as “Add Flag to Total Flags” 875, indicating an aggregation of flagged transactions. The result of this transformation is stored in a target table labeled “Database 3” 880, in the target field “Transaction Report” 885.

Table 830 provides a consolidated lineage view that links the mappings from Tables 800 and 810. It includes the source tables and fields from both prior mappings—Database 1 850, Account Transaction 855; and Database 2 865, Transaction Flag 870—as well as the final target table and field, Database 3 880, Transaction Report 885. The composite view in table 830 demonstrates how data originating in Database 1 is transformed and propagated through Database 2 before reaching its final form in Database 3. The lineage shown in Table 830 enables traceability of the data flow and transformation logic across multiple STM documents.

In further embodiments, the lineage report generated from linked STM documents may take multiple forms, including graphical representations (e.g., flow diagrams), textual descriptions, or structured tables. These formats may be selected based on user preference, system capabilities, or the intended use of the lineage output, such as auditing, debugging, or compliance verification.

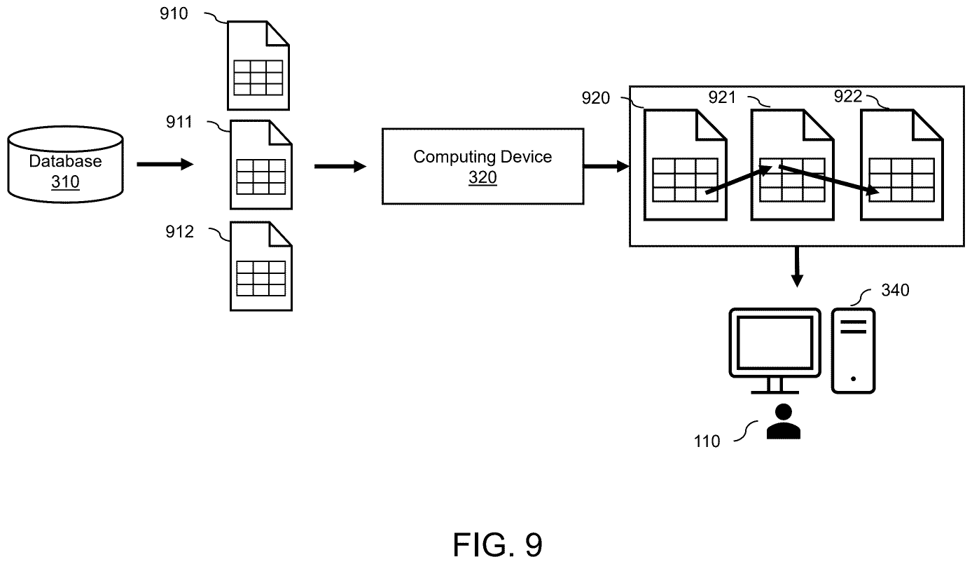

FIG. 9 illustrates an exemplary system architecture for analyzing source-to-target mapping documentation and linking them according to data lineage, consistent with some disclosed embodiments.

The system may include a database 310, which may store previously generated STM documents. These documents may include mappings between source fields and target fields, transformation logic, and/or metadata relevant to data lineage and compliance.

Elements 910, 911, and 912 may represent STM documents that have been generated but are not yet connected or analyzed for lineage. These documents may contain mappings and transformation logic but may lack contextual linkage to other STM records. As such, they may not yet provide a complete view of how data flows across systems or through multiple transformation stages.

The computing device 320 may access the database and serve as the central processing unit for STM analysis. According to some embodiments, this device may be a server, workstation, or cloud-based node and includes hardware and software components necessary for retrieving STM documents, executing transformation logic, and performing lineage analysis as described herein.

Following this, elements 920, 921, and 922 may represent STM documents that have been analyzed for data lineage. These documents may include additional metadata and relational context that may reveal how data has moved through various mappings and transformations. Examples of such metadata may include timestamps indicating when a transformation occurred, the identity of the system or user that executed the mapping, version history of the code script, and identifiers for source and target systems. Metadata may also include transformation types, field-level annotations, and lineage tags that link related STM documents together. According to some embodiments, the lineage analysis may identify the origin of specific data fields, the sequence of transformations applied, and the final destination of the data. This enriched documentation may support auditability, compliance verification, and improved traceability across enterprise systems.

After STM documents have been analyzed for data lineage, entity 110 may interact with the system to explore and interpret the results through the endpoint device 340. According to some embodiments, the end user may view linked STM documents, trace the flow of data across multiple mappings, and examine how specific data fields have been transformed or transferred through various systems. According to some embodiments, an end user may view a visual diagram that shows how data flows from its source through various transformations to its final destination. Further embodiments may include an end user clicking through linked STM documents to follow a specific data field across systems. Further methods may include using a table that lists source fields, transformation logic, and target fields, making it easy to trace relationships. This interaction may enable the user to validate lineage paths, identify inconsistencies, and gain insights into the origin and destination of critical data elements.

The enriched STM documents—represented by elements 920, 921, and 922—may include additional metadata or visual indicators that highlight lineage relationships, allowing entity 110 to make informed decisions regarding data governance, audit readiness, or documentation updates.

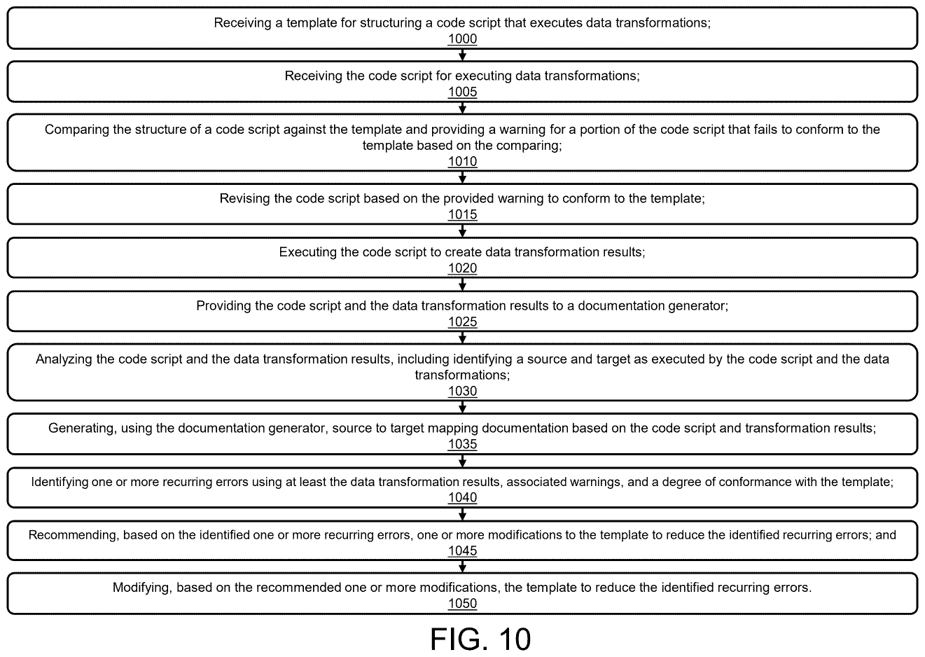

FIG. 10 is a flowchart illustrating an example process for improving the efficiency of creating source-to-target mapping templates. In step 1000, the process may include receiving a template for structuring a code script that executes data transformations, which may be substantially similar to step 500 of FIG. 5 described above.

In step 1005, the process may further include receiving the code script for executing data transformations, which may be substantially similar to step 510 of FIG. 5 described above.

In step 1010, the process may include comparing the structure of a code script against the template and providing a warning for a portion of the code script that fails to conform to the template based on the comparing, which may be substantially similar to step 520 of FIG. 5 described above.

In step 1015, the process may include revising the code script based on the provided warning to conform to the template, which may be substantially similar to step 530 of FIG. 5 described above.

In step 1020, the process may include executing the code script to create data transformation results, which may be substantially similar to step 540 of FIG. 5 described above.

In step 1025, the process may include providing the code script and the data transformation results to a documentation generator, which may be substantially similar to step 550 of FIG. 5 described above.

In step 1030, the process may include analyzing the code script and the data transformation results, including identifying a source and target as executed by the code script and the data transformations, which may be substantially similar to step 560 of FIG. 5 described above.

In step 1035, the process may include generating, using the documentation generator, source to target mapping documentation based on the code script and transformation results, which may be substantially similar to step 570 of FIG. 5 described above.

In step 1040, the process described in FIG. 10 may further include identifying one or more recurring errors using at least the data transformation results, associated warnings, and a degree of conformance with the template. This analysis may use rule-based logic, pattern recognition, machine learning to detect common failure modes or inefficiencies, or other similar algorithms.

In step 1045, the process may further include recommending, based on the identified one or more recurring errors, one or more modifications to the template to reduce the identified recurring errors. Recommendations may include changes to instructions, structure, or validation rules to improve future code quality and reduce error rates. According to some embodiments, the recommended modifications to the template are prioritized based on the frequency of the identified recurring errors.

In step 1050, the process may further include modifying, based on the recommended one or more modifications, the template to reduce the identified recurring errors. This iterative refinement enables continuous improvement of coding standards and enhances the reliability of STM documentation generated from future code scripts. The modification may be done by a developer or by rule-based logic, pattern recognition, machine learning, or other similar algorithms. According to some embodiments, the process may include automatically updating the template or STM documentation with the recommended modifications upon satisfying a predefined confidence threshold. The predefined confidence threshold can be determined using statistical analysis or the like to assess the likelihood of improved efficiencies to the template.

In further embodiments, the process includes evaluating the effectiveness of the modified template by monitoring a reduction in recurring errors over time. The system may compute performance metrics such as error frequency, resolution time, and documentation success rate before and after template modifications. In some embodiments, statistical models or machine learning algorithms may be employed to assess the significance of observed improvements and to isolate the impact of individual template changes. This historical data can also be used to produce improved modification recommendations through a feedback loop, enabling the system to prioritize future template updates based on empirical evidence.

In further embodiments, the method further comprises generating a report summarizing the recurring errors, proposed template modifications, and their expected impact on documentation quality. The report may include a categorized breakdown of error types—such as structural deviations, syntax violations, or transformation mismatches—along with frequency metrics and contextual examples drawn from the analyzed code scripts. Each proposed modification to the template may be accompanied by a rationale, including the specific error it addresses, the anticipated reduction in error rate, and any dependencies or constraints. The report may also include predictive modeling outputs that estimate the improvement in documentation accuracy, consistency, and generation speed resulting from the adoption of the proposed changes. In some embodiments, the report may be formatted for integration into governance dashboards or compliance review workflows, enabling stakeholders to track template evolution, validate changes, and ensure alignment with organizational standards.

It is to be understood that some or all of the steps described in the disclosed systems and methods may be performed wholly or in part by AI or machine learning. Artificial neural networks may be configured to analyze STM data and make determinations on best practices and comparison analysis. Some non-limiting examples of such artificial neural networks may include shallow, deep, feedback, feedforward, autoencoder, probabilistic, time delay, convolutional, recurrent, and long short-term memory neural networks, among others. In certain cases, an artificial neural network can be manually configured.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions that implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions that execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which includes one or more executable instructions for implementing the specified logical function(s). It should also be noted that, in some alternative implementations, the functions noted in the block may occur out of the order noted in the figures. Some steps may be deleted, added, or modified. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1.-20. (canceled)

21. A computer-implemented method for modifying a template for structuring a code script, the method comprising the following operations performed by one or more processors:
receiving a template for structuring a code script that executes data transformations;
receiving the code script for executing data transformations;
comparing the structure of a code script against the template and providing a warning for a portion of the code script that fails to conform to the template based on the comparing;
revising the code script based on the provided warning to conform to the template;
executing the code script to create data transformation results;
providing the code script and the data transformation results to a documentation generator;
analyzing the code script and the data transformation results, including identifying a source and target as executed by the code script and the data transformations;
generating, using the documentation generator, source-to-target mapping documentation based on the code script and transformation results;
wherein the source-to-target mapping documentation includes a target attribute, a source attribute, a source table, a transformation, a log of information collection progress, and a data-collection warning;
identifying one or more recurring errors using at least the data transformation results, associated warnings, and a degree of conformance with the template;
recommending, based on the identified one or more recurring errors, one or more modifications to the template to reduce the identified recurring errors; and
modifying, based on the recommended one or more modifications, the template to reduce the identified recurring errors.

22. The method of claim 21, wherein the recommended modifications to the template are prioritized based on a frequency of the identified recurring errors.

23. The method of claim 21, wherein the method further comprises automatically updating the template with the recommended modifications upon satisfying a predefined confidence threshold.

24. The method of claim 21, wherein the method further comprises monitoring a reduction in recurring errors over time associated with the modified template.

25. The method of claim 21, wherein the method further comprises generating a report summarizing the recurring errors, proposed template modifications, and their expected impact on documentation quality.

26. The method of claim 21, wherein the recommended one or more modifications are to the source-to-target mapping documentation.

27. The method of claim 21, wherein the analyzing the code script and the data transformation results and the identifying one or more recurring errors are performed by a machine learning algorithm.

28. A system for modifying a template for structuring a code script comprising:
a memory device including program instructions; and
at least one processor configured to execute the program instructions to:
receive a template for structuring a code script that executes data transformations;
receive the code script for executing data transformations;
compare the structure of a code script against the template and providing a warning for a portion of the code script that fails to conform to the template based on the comparing;
revise the code script based on the provided warning to conform to the template;
execute the code script to create data transformation results;
provide the code script and the data transformation results to a documentation generator;
analyze the code script and the data transformation results, including identifying a source and target as executed by the code script and the data transformations;
generate, using the documentation generator, source-to-target mapping documentation based on the code script and transformation results;
wherein the source-to-target mapping documentation includes a target attribute, a source attribute, a source table, a transformation, a log of information collection progress, and a data-collection warning;
identify one or more recurring errors using at least the data transformation results, associated warnings, and a degree of conformance with the template;
recommend, based on the identified one or more recurring errors, one or more modifications to the template to reduce the identified recurring errors; and
modify, based on the recommended one or more modifications, the template to reduce the identified recurring errors.

29. The system of claim 28, wherein the recommended modifications to the template are prioritized based on a frequency of the identified recurring errors.

30. The system of claim 28, wherein the program instructions further comprise providing automatic modification to the template with the recommended modifications upon satisfying a predefined confidence threshold.

31. The system of claim 28, wherein the program instructions further comprise monitoring a reduction in recurring errors over time associated with the modified template.

32. The system of claim 28, wherein the program instructions further comprise providing a report summarizing the recurring errors, proposed template modifications, and their expected impact on documentation quality.

33. The system of claim 28, wherein the recommended one or more modifications are to the source-to-target mapping documentation.

34. The system of claim 28, wherein the program instructions to analyze the code script and the data transformation results and identify one or more recurring errors are performed by a machine learning algorithm.

35. A non-transitory computer-readable medium storing instructions for modifying a template for structuring a code script that, when executed by a processor, cause the processor to:
receive a template for structuring a code script that executes data transformations;
receive the code script for executing data transformations;
compare the structure of a code script against the template and providing a warning for a portion of the code script that fails to conform to the template based on the comparing;
revise the code script based on the provided warning to conform to the template;
execute the code script to create data transformation results;
provide the code script and the data transformation results to a documentation generator;
analyze the code script and the data transformation results, including identifying a source and target as executed by the code script and the data transformations;
generate, using the documentation generator, source-to-target mapping documentation based on the code script and transformation results;
wherein the source-to-target mapping documentation includes a target attribute, a source attribute, a source table, a transformation, a log of information collection progress, and a data-collection warning;
identifying one or more recurring errors using at least the data transformation results, associated warnings, and a degree of conformance with the template;
recommending, based on the identified one or more recurring errors, one or more modifications to the template to reduce the identified recurring errors; and
modifying, based on the recommended one or more modifications, the template to reduce the identified recurring errors.

36. The non-transitory computer-readable medium of claim 35, wherein the recommended modifications to the template are prioritized based on a frequency of the identified recurring errors.

37. The non-transitory computer-readable medium of claim 35, wherein the instructions further comprise providing automatic modification to the template with the recommended modifications upon satisfying a predefined confidence threshold.

38. The non-transitory computer-readable medium of claim 35, wherein the instructions further comprise monitoring a reduction in recurring errors over time associated with the modified template.

39. The non-transitory computer-readable medium of claim 35, wherein the instructions further comprise providing a report summarizing the recurring errors, proposed template modifications, and their expected impact on documentation quality.

40. The non-transitory computer-readable medium of claim 35, wherein the recommended one or more modifications are to the source-to-target mapping documentation.
